(19) United States
(12) Patent Application Publication
(10) Pub. No.: US 2007/0158466 A1
(43) Pub. Date: Jul. 12, 2007

(54) Nozzle assembly

(76) Inventors: Michael P. Harmon, Dunlap, IL (US); Cho Y. Liang, Henderson, NV (US)

Correspondence Address: CATERPILLAR/FINNEGAN, HENDERSON, L.L.P., 901 New York Avenue, NW, WASHINGTON, DC, 20001-4413, US

(21) Appl. No.: 11/319,378

(22) Filed: Dec. 29, 2005

(51) Int. Cl. B05B 7/04; B05B 7/12; F23D 11/10

(52) U.S. Cl. 239/398; 239/416; 239/418

(57) ABSTRACT

A nozzle assembly includes a housing defining a first fluid passage in fluid communication with a second fluid passage, and a sleeve disposed within the housing and fluidly connected to the first and second fluid passages. The housing defines a radial fluid passage proximate a front end of the sleeve. The nozzle assembly also includes at least one orifice in selective communication with a regeneration device.

### TECHNICAL FIELD

The present disclosure is directed to a nozzle assembly and, more particularly, to a nozzle assembly configured to be cooled by a fluid.

### BACKGROUND

Engines, including diesel engines, gasoline engines, natural gas engines, and other engines known in the art, may exhaust a complex mixture of air pollutants. The air pollutants may be composed of both gaseous and solid material, such as, for example, particulate matter. Particulate matter may include ash and unburned carbon particles called soot.

Due to increased environmental concerns, some engine manufacturers have developed systems to treat engine exhaust after it leaves the engine. Some of these systems employ exhaust treatment devices, such as particulate traps, to remove particulate matter from the exhaust flow. A particulate trap may include filter material designed to capture particulate matter. After an extended period of use, however, the filter material may become partially saturated with particulate matter, causing engine performance to suffer.

The collected particulate matter may be removed from the filter material through a process called regeneration. A particulate trap may be regenerated by increasing the temperature of the filter material and the trapped particulate matter above the combustion temperature of the particulate matter, thereby burning away the collected particulate matter. This increase in temperature may be effectuated by various means. For example, some systems may employ a heating element to directly heat one or more portions of the particulate trap (e.g., the filter material or the external housing). Other systems have been configured to heat exhaust gases upstream of the particulate trap. The heated gases then flow through the particulate trap and transfer heat to the filter material and captured particulate matter. Such systems may alter one or more engine operating parameters, such as the ratio of air to fuel in the combustion chambers, to produce exhaust gases with an elevated temperature. Alternatively, such systems may heat the exhaust gases upstream of the particulate trap with, for example, a burner disposed within an exhaust conduit leading to the particulate trap.

One such system is disclosed by U.S. Pat. No. 4,651,524, issued to Brighton on Mar. 24, 1987 (“the '524 patent”). The '524 patent discloses an exhaust treatment system configured to increase the temperature of exhaust gases with a burner.

While the system of the '524 patent may increase the temperature of the particulate trap, the regeneration device of the '524 patent is not configured such that a portion of the device may be actively cooled before, during, and/or after regenerating the particulate trap. As a result, components of the device may become clogged over time due to fuel remaining in the device while the device is at an elevated temperature after regeneration. Clogging of the device may reduce the effectiveness of the device and hinder device performance.

The disclosed nozzle assembly is directed toward overcoming one or more of the problems set forth above.

### SUMMARY OF THE INVENTION

In one exemplary embodiment of the present disclosure, a nozzle assembly includes a housing defining a first fluid passage in fluid communication with a second fluid passage, and a sleeve disposed within the housing and fluidly connected to the first and second fluid passages. The housing defines a radial fluid passage proximate a front end of the sleeve. The nozzle assembly also includes at least one orifice in selective communication with a regeneration device.

In another exemplary embodiment of the present disclosure, a nozzle assembly includes a housing defining a first fluid passage in fluid communication with a second fluid passage, and a third fluid passage in fluid communication with a fourth fluid passage. The nozzle assembly also includes a sleeve disposed within the housing. The sleeve defines a bypass passage configured to assist in fluidly connecting the first fluid passage and the second fluid passage. The housing further defines a radial fluid passage proximate a front end of the sleeve. The nozzle assembly also includes at least one orifice in selective communication with a regeneration device.

In still another exemplary embodiment of the present disclosure, a method of cooling a portion of a nozzle assembly includes controllably restricting a flow of a first fluid to at least one of a first fluid passage and a second fluid passage of the nozzle assembly. The method further includes directing a flow of a second fluid to a radial fluid passage of the nozzle assembly. The first fluid is a different fluid than the second fluid.

### BRIEF DESCRIPTION OF THE DRAWINGS

FIG. 1 is a diagrammatic illustration of a nozzle assembly connected to a first fluid source and a second fluid source according to an exemplary embodiment of the present disclosure.

FIG. 2 is a diagrammatic illustration of a regeneration device connected to a power source according to another exemplary embodiment of the present disclosure.

### DETAILED DESCRIPTION

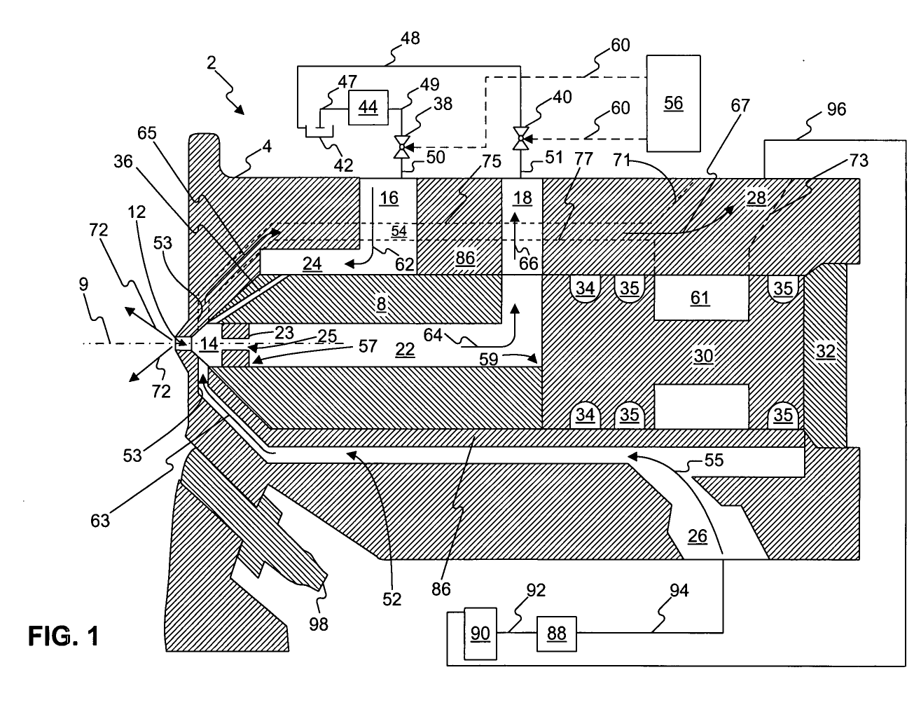

As shown in FIG. 1, a nozzle assembly 2 includes a housing 4 and a sleeve 8 disposed within a channel 24 of the housing 4. A front end 57 of the sleeve 8 abuts the housing 4 and a back end 59 of the sleeve 8 abuts a stop 30 of the nozzle assembly 2. The stop 30 and the sleeve 8 are secured against the housing 4 with a set screw 32.

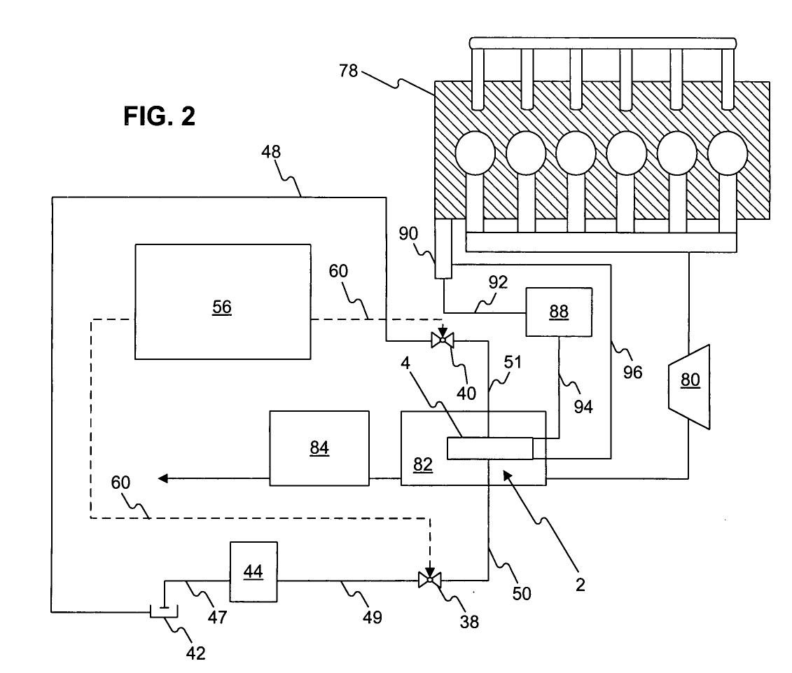

The housing 4 may be, for example, a manifold or any other like structure capable of supporting components of a nozzle assembly and assisting in forming a chamber 14 for swirling fluid to be injected by the nozzle assembly 2. As shown in FIG. 1, the sleeve 8, the stop 30, and the set screw 32 may be at least partially supported by and/or connected to the housing 4. An ignition device 98 may also be supported and/or connected to the housing 4. Such ignition devices 98 may include, for example, a spark plug or other conventional ignition devices. The housing 4 may be made of any materials known in the art capable of withstanding particulate filter regeneration temperatures. Such materials may include, for example, platinum, steel, aluminum, and/or any alloys thereof. In addition, the housing 4 may be made of cast iron or any other cast material. As will be discussed below with respect to FIG. 2, the housing 4 and/or other components of the nozzle assembly 2 may be sized and/or otherwise configured to be mounted to a regeneration device 82.

The housing 4 may define a first fluid passage 18 and a second fluid passage 16. The housing 4 may further define a third fluid passage 28 (illustrated by dashed lines 71, 73 in FIG. 1) and a fourth fluid passage 26. The first fluid passage 18 may be fluidly connected to the second fluid passage 16, and the third fluid passage 28 may be fluidly connected to the fourth fluid passage 26. As will be described in greater detail below, the first fluid passage 18 may be fluidly connected to the second fluid passage 16 via, for example, the channel 24 of the housing 4, at least one of a plurality of slots 36 defined by the sleeve 8, and a bypass passage 22 of the sleeve 8. In addition, the third fluid passage 28 may be fluidly connected to the fourth fluid passage 26 via, for example, a first channel 54 (illustrated by dashed lines 75, 77 in FIG. 1), a second channel 52, and a first radial passage 53 of the housing 4.

As shown in FIG. 1, the housing 4 may define at least one orifice 12. The orifice 12 may be sized, angled, and/or otherwise configured to inject a conical-shaped flow of fluid into, for example, the regeneration device 82 (FIG. 2). The housing 4 may assist in defining the chamber 14 proximate the front end 57 of the sleeve 8. The chamber 14 may also be sized, shaped, and/or otherwise configured to assist in injecting the conical flow of fluid.

The first radial passage 53 may be a channel that is milled, drilled, cut, etched, and/or otherwise formed in a wall of the housing 4. The first radial passage 53 may be formed so as to extend substantially around a perimeter or circumference of the front end 57 of the sleeve 8. Thus, fluid passing through the first radial passage 53, from the second channel 52 to the first channel 54, may be contained completely within the first radial passage 53. A fluid path formed by the first radial passage 53 may, thus, be separate from an additional fluid path formed by, for example, the channel 24, the plurality of slots 36, the chamber 14, and/or the bypass passage 22. Moreover, the first and second channels 54, 52 may be formed in substantially the same way as the first radial passage 53, and the first and second channels 54, 52 may extend from the first radial passage 53 proximate an outer surface of the sleeve 8. It is understood that it may be desirable to minimize the thickness of a housing wall 86 proximate the outer surface of the sleeve 8 such that relatively low temperature fluid flowing through the first and second channels 54, 52 may efficiently extract heat from, for example, portions of the housing 4, the stop 30, and/or the sleeve 8 through conduction and/or convection. In particular, it may be desirable to extract heat from the plurality of slots 36, and/or the portion of the housing 4 proximate the orifice 12 and the chamber 14. These components of the nozzle assembly 2 may have the greatest likelihood of corrosion, coking, and/or otherwise clogging due to their close proximity to the combustion reaction within the regeneration device 82 (FIG. 2) and relatively small size. Accordingly, in an exemplary embodiment of the present disclosure, the first and second channels 54, 52 may be formed as close to the channel 24 of the housing 4 as possible while maintaining a desirable level of structural integrity within the housing 4.

The sleeve 8 may abut an inner surface of the housing 4 so as to form a fluid seal therebetween. The fluid seal may be capable of withstanding fluid pressures in excess of, for example, 250 psi during operation of the nozzle assembly 2. The sleeve 8 may be substantially cylindrical and substantially hollow, and may be made of any of the metals discussed above with respect to the housing 4. The plurality of slots 36 defined by the sleeve 8 may be in fluid communication with the channel 24 of the housing 4 and the chamber 14. The plurality of slots 36 may be disposed at any desirable angle relative to a longitudinal axis 9 of the sleeve 8 to assist in injecting fluid into the chamber 14 at an angle. The plurality of slots 36 may have any diameter useful in delivering a desired amount of fluid to the chamber 14 over a range of desired pressures. The diameter of the slots 36 may be relatively small compared to, for example, a diameter of the bypass passage 22.

The bypass passage 22 may be milled, drilled, cut, etched, and/or otherwise formed in the sleeve 8. In an exemplary embodiment, the bypass passage 22 may extend substantially the entire length of the sleeve 8, from the front end 57 to the back end 59. The bypass passage 22 may be formed substantially parallel to the longitudinal axis 9 of the sleeve 8 and may be fluidly connected to the chamber 14. The bypass passage 22 may also be fluidly connected to the plurality of slots 36 and the first fluid passage 18. The bypass passage 22 may include a restriction 23 disposed proximate the chamber 14. The restriction 23 may be, for example, made of the same material as the sleeve 8. Alternatively, the restriction may be, for example, a portion of a tube, pipe and/or other structure connected to the sleeve 8 and disposed within the bypass passage 22. The restriction 23 may define a relatively small orifice 25. A centerline of the orifice 25 may be aligned with the longitudinal axis 9 of the sleeve 8 and/or a centerline of the chamber 14. The diameter of the orifice 25 may be optimized as a design parameter of the nozzle assembly 2 based on a desired fluid flow rate through the orifice 12. In an exemplary embodiment, the diameter of the orifice 25 may be 0.010 inches.

The stop 30 may be, for example, any conventional mechanical spacer. The stop 30 may be made from any of the metals discussed above with respect to the housing 4 and may be sized, shaped, and/or configured to secure the sleeve 8 tightly against, for example, the housing 4 when the set screw 32 is fully tightened. The stop 30 may be substantially noncompressible and may define at least one groove configured to accept a seal 34. The groove may have any configuration and, in an exemplary embodiment, the groove may extend around a perimeter or circumference of the stop 30. The seal 34 may be configured to form a fluid seal between, for example, the housing 4 and the stop 30. In an exemplary embodiment, the seal 34 may be an O-ring made of any conventional plastic, rubber, polymer, or composite useful in applications where gasoline, diesel, and/or other petroleum based fluids are used. Such materials may include, for example, Viton® or other fluoroelastomers. The seal 34 may be configured to form a fluid seal when fluid pressures within the housing 4 exceed, for example, 250 psi, and the set screw 32 may assist in forming such a seal. In an additional exemplary embodiment, the stop 30 may include a number of additional seals 35 disposed within distinct respective grooves defined by the stop 30. The additional seals 35 may be mechanically similar to the seal 34, and may be, for example, O-rings made of any conventional plastic, rubber, polymer, or composite useful in applications where fluids such as water, glycol, and/or other coolants are used.

The stop 30 may further define a relatively large central groove extending substantially circumferentially around the stop 30. This central groove may be milled, drilled, cut, etched, and/or otherwise formed in the stop 30, and may assist in forming a second radial passage 61 when the stop 30 is disposed within the channel 24 of the housing 4. The second radial passage 61 may be fluidly connected to the first channel 54 and the third fluid passage 28. It is understood that relatively low temperature fluid flowing through the first and second channels 54, 52, and through the second radial passage 61, may extract heat from, for example, portions of the housing 4, the stop 30, and/or the sleeve 8 through conduction.

At least one valve may be fluidly connected to the housing 4 to assist in controlling the flow of fluid therein. For example, a valve 40 may be fluidly connected to the first fluid passage 18 via fluid line 51, and a valve 38 may be fluidly connected to the second fluid passage 16 via fluid line 50. In general, the fluid lines described herein may be any conventional pipes, hoses, and/or other like structures configured to transmit pressurized fluid at pressures in excess of, for example, approximately 250 psi. The valves 40, 38 may be any type of controllable two-way valve known in the art. The valves 40, 38 may include an actuation device (not shown), such as, for example, a solenoid, to assist in regulating a flow of fluid therethrough. In an exemplary embodiment, at least one of the valves 40, 38 may be variably regulated. A portion of each valve 40, 38, such as, for example, the actuation device, may be electrically connected to a controller 56. The dotted control lines 60 shown in FIG. 1 illustrate such a connection. The controller 56 may be, for example, an electronic control unit, a computer, and/or any other conventional data processor configured to control the position and/or functionality of valves 40, 38.

The valves 40, 38, may also be fluidly connected to a tank 42. The tank 42 may be, for example, a low pressure sump, a fuel tank, a secondary fuel circuit of a work machine, and/or any other low pressure fluid source known in the art. The tank 42 may contain, for example, diesel fuel, and may be connected to a conventional pressure source, such as a pump 44. In an exemplary embodiment, the pump 44 may be configured to draw fluid from the tank 42, via a fluid line 47, and direct the drawn fluid to valve 38 via a fluid line 49. In such an embodiment, the valve 40 may be fluidly connected to the tank 42 via fluid line 48. The fluid lines 47, 48, 49 may be mechanically similar to the fluid lines 51, 50 discussed above. The pump 44 may assist in directing the fluid to the valve 38 at any desirable fluid pressure and may be any type of pump known in the art, such as, for example, an impeller-type pump. In an exemplary embodiment, the pump 44 may direct fluid to the valve 38 at approximately 250 psi or more.

As shown in FIG. 1, the third and fourth fluid passages 28, 26 of the housing 4 may be fluidly connected to a reservoir 90. The reservoir 90 may be, for example, a low pressure sump, a radiator of a work machine, a water or other coolant tank, a coolant circuit of a work machine, and/or any other low pressure fluid source known in the art. The reservoir 90 may contain, for example, water, glycol, refrigerant, and/or other coolants or fluids, and may be connected to a conventional pressure source, such as, for example, a pump 88. In an exemplary embodiment, the pump 88 may be mechanically similar to the pump 44 described above. The pump 88 may be configured to draw coolant and/or other fluids from the reservoir 90, via a coolant line 92, and direct the drawn fluid to the fourth fluid passage 26 via a coolant line 94. In such an exemplary embodiment, the pump 88 may direct fluid to the fourth fluid passage 26 at approximately 20 psi or more. In addition, fluid exiting the housing 4 through the third fluid passage 28 may be directed to the reservoir 90 via a coolant line 96. The coolant lines 92, 94, 96 may be mechanically similar to the fluid lines 51, 50 discussed above.

### INDUSTRIAL APPLICABILITY

As shown in FIG. 2, in an exemplary embodiment of the present disclosure, the disclosed nozzle assembly 2 may be used in combination with a regeneration device 82 to assist in purging contaminants collected within a filter 84. Such filters 84 may include any type of filters known in the art, such as, for example, particulate filters, useful in extracting pollutants from a flow of liquid. Such filters 84, and thus, the regeneration device 82, may be fluidly connected to an exhaust outlet of, for example, a diesel engine or other power source 78 known in the art. The power source 78 may be used in any conventional application where a supply of power is required. For example, the power source 78 may be used to supply power to stationary equipment, such as power generators, or other mobile equipment, such as vehicles. Such vehicles may include, for example, automobiles, work machines (including those for on-road, as well as off-road use), and other heavy equipment.

A flow of exhaust produced by the power source 78 may pass from the power source 78, through an energy extraction assembly 80, and into the regeneration device 82. It is understood that in an exemplary embodiment of the present disclosure, the energy extraction assembly 80 may be omitted. Under normal power source operating conditions, the regeneration device 82 may be deactivated, and the flow of exhaust may pass through the regeneration device 82 to the filter 84, where a portion of the pollutants carried by the exhaust may be captured. Over time, however, the filter 84 may become saturated with collected pollutants, thereby hindering its ability to remove pollutants from the flow of exhaust. A saturated filter 84 may also create backpressure on the power source 78, degrading power source performance and increasing fuel consumption. One or more diagnostic devices (not shown) may be used to detect, for example, filter temperature, flow rate, flow temperature, filtered flow particulate content, exhaust backpressure, and/or other characteristics of the filter 84, the power source 78, and/or the flow, and may send this information to the controller 56. The controller 56 may use the information to determine when the filter 84 requires regeneration. This determination may also be based on a predetermined regeneration schedule, the gallons of fuel burned by the power source 78, and/or models, algorithms, or maps stored in a memory of the controller 56.

The regeneration device 82 may be configured to raise the temperature of a flow of exhaust passing through it, thereby generating an output flow capable of regenerating the filter 84. The temperature of the flow may be elevated by injecting a flammable fluid, such as, for example, diesel fuel, into the regeneration device 82 using the nozzle assembly 2, and igniting the fluid within the regeneration device 82. The operation of the nozzle assembly 2 will now be described in detail with respect to FIG. 1, unless otherwise noted. As mentioned above, it is understood that the dashed lines 60 originating from the controller 56 in FIG. 1 represent electrical or other control lines. The solid lines connecting each of the components of FIG. 1 represent fluid flow lines or coolant lines. It is further understood that the fluid discussed for the duration of this disclosure may be, for example, gasoline, diesel fuel, reformate, or any other conventional combustible fluid. The fluid may be ignited within the regeneration device 82 to increase the temperature of the exhaust flow. In addition, the coolant discussed for the duration of this disclosure may be, for example, water, glycol, refrigerant, and/or any other conventional fluids used to cool work machine and/or automotive components. The coolant may be used to conductively cool portions of the nozzle assembly 2 before, during, and/or after a regeneration process. It is contemplated that a flow of a first fluid and a flow of a second fluid may be directed through components of the nozzle assembly 2, and that the first fluid may be a different fluid than the second fluid. It is also contemplated that the first and second fluids may be the same fluid. In such an embodiment, the fluid may be, for example, diesel fuel, gasoline, and/or any other conventional combustible fluid.

To begin injecting fluid using the nozzle assembly 2, the controller 56 may substantially open the valves 38 and 40. The pump 44 may supply fluid to the second fluid passage 16 at a pressure of, for example, approximately 250 psi, and the fluid line 47 may direct the fluid to the pump 44 from the tank 42. The fluid may then be directed from the pump 44 to the valve 38 through the fluid line 49. The flow of fluid entering the second fluid passage 16 through fluid line 50, and thus, the amount of fluid provided to the regeneration device 82 (FIG. 2), may be regulated by valve 40. For example, to increase the amount of fluid directed to the second fluid passage 16 and/or the regeneration device 82, a user may manipulate the valve 40 to a relatively closed position. Controlling the valves 38, 40 in this way will direct the fluid to flow from the second fluid passage 16 in the direction of arrow 62.

The fluid may then flow through the channel 24, through the plurality of slots 36, and may enter the chamber 14. The fluid may enter the chamber 14 at an angle based on the configuration of the slots 36 and may exit the orifice 12 in a conical direction as illustrated by arrows 72. It is understood, however, that not all of the fluid entering the chamber 14 may exit the orifice 12. The fluid that is not injected into the regeneration device 82 (FIG. 2) may enter the bypass passage 22 and may travel to the first fluid passage 18 in the direction of arrow 64. This fluid may exit the housing 4 in the direction of arrow 66 and may pass through the fluid line 51 and the substantially open valve 40 before returning to the tank 42 via fluid line 48. It is understood that the restriction 23 may assist the valve 40 in regulating the amount of fluid passing through the bypass passage 22. In an exemplary embodiment, the fluid injected into the chamber 14 may swirl within the chamber 14 and the fluid flowing along the walls of the chamber 14 (i.e., the fluid on the outside of the swirl) may have a greater amount of kinetic and/or other energy than the fluid proximate the longitudinal axis 9 and/or the centerline of the chamber 14 (i.e., the fluid at the center of the swirl). The orifice 25 of the restriction 23 may be positioned and dimensioned to siphon, guide, and/or otherwise draw fluid from the center of the swirl and direct the fluid to the bypass passage 22. Drawing relatively low energy fluid from the center of the swirl may minimize the disturbances to the fluid injected into the chamber 14 from the plurality of slots 36.

Once fluid is injected into the regeneration device 82, the ignition device 98 may be used to ignite the fluid. Ignition and combustion of the fluid may cause the exhaust gas and, thus, the components of the nozzle assembly 2 to increase in temperature. During extended regeneration processes, the exhaust gas may reach, for example, approximately 600 degrees Celsius or more. Because the components of the nozzle assembly 2 are cooled during regeneration, however, the components may remain at temperatures below the heated exhaust gas temperature.

To stop injecting fluid into the regeneration device 82, and to thereby end the active regeneration process, the controller 56 may close the valve 38 and may keep the valve 40 substantially open. When the valve 38 is closed, no fluid will be allowed to enter the housing 4 from the pump 44, and the pump 44 may be deactivated while the valve 38 is closed. It is understood that once the valve 38 is closed, the valve 40 may no longer be used to regulate a flow of fluid within the housing 4.

Once the regeneration process is completed, unburned fluid may remain within components of the nozzle assembly 2, such as, for example, the slots 36 of the sleeve 8. Fluid remaining within such components may begin to coke and/or corrode the components when the components are at elevated temperatures for extended periods of time. Unburned fluid remaining in the nozzle assembly may also form deposits within components of the nozzle assembly 2 such as, for example, the slots 36 and/or the orifice 12. Such corrosion and deposits may clog the passages of such components and may reduce, for example, the effectiveness and/or the useful life of the nozzle assembly 2. Cooling the components of the nozzle assembly 2, however, may reduce corrosion and/or deposit formation after repeated regeneration processes and may extend the life of the nozzle assembly 2. As will be described below, the nozzle assembly 2 of the present disclosure may be cooled with coolant, for example, before a regeneration process, while fluid is being injected into the regeneration device 82 during regeneration, and after fluid is no longer being injected into the regeneration device 82 (i.e. after the regeneration process has been completed). Thus, the components of the nozzle assembly 2 may be continuously cooled by the coolant during operation of the work machine to which the nozzle assembly 2 is attached.

Coolant may be drawn from the reservoir 90 through the coolant line 92 by the pump 88. The pump 88 may direct the coolant to the fourth fluid passage 26 through the coolant line 94 at, for example, approximately 20 psi. The coolant may travel in the direction of arrow 55 through the second channel 52, and may enter the first radial passage 53 as illustrated by arrow 63. The coolant may be carried around a perimeter or circumference of the sleeve 8 by the first radial passage 53. The first radial passage 53 may be disposed proximate the front end 57 of the sleeve 8, as well as proximate the chamber 14 and/or orifice 12 of the housing 4. As a result, the coolant passing through the first radial passage 54 may assist in conductively and/or convectively removing heat from, for example, portions of the sleeve 8, the chamber 14, and/or the orifice 12 as the coolant passes through the housing 4. The coolant may travel in the direction of arrow 65 and may then enter the first channel 54. The coolant may pass from the first channel 54 to the third fluid passage 28 in the direction of arrow 67, and may be directed back to the reservoir 90 via the coolant line 96. The first and second channels 54, 52 may be formed as close as possible to, for example, the channel 24 within which the sleeve 8 and/or the stop 30 is disposed. Accordingly, coolant passing through the first and second channels 54, 52 may assist in conductively and/or convectively removing heat from, for example, portions of the sleeve 8, the stop 30, the chamber 14, and/or the orifice 12 as the coolant passes through the housing 4.

As described above, the third fluid passage 28 may be fluidly connected to the second radial passage 61. Accordingly, the coolant may also pass from the first channel 54 circumferentially around the stop 30 through the second radial passage 61 before exiting the housing 4 through the third fluid passage 28. Coolant passing through the second radial passage 61 may assist in conductively and/or convectively cooling portions of the stop 30, the sleeve 8, and/or the housing 4. It is understood that the pump 88 may continuously direct coolant through the housing 4 independent of the regeneration schedule of the filter 84 (FIG. 2).

It will be apparent to those having ordinary skill in the art that various modifications and variations can be made to the disclosed nozzle assembly 2 without departing from the scope of the invention. For example, although the nozzle assembly 2 is disclosed herein as having multiple distinct components, it is understood that one or more of the distinct components, such as, for example, the sleeve 8 and the stop 30, may be combined to form a single component. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A nozzle assembly, comprising:
a housing defining a first fluid passage in fluid communication with a second fluid passage;
a sleeve disposed within the housing and fluidly connected to the first and second fluid passages, the housing defining a radial fluid passage proximate a front end of the sleeve; and
at least one orifice in selective communication with a regeneration device.

2. The nozzle assembly of claim 1, wherein the housing further includes a third fluid passage fluidly connected to a fourth fluid passage.

3. The nozzle assembly of claim 2, wherein the housing further defines a first channel fluidly connecting the third fluid passage to the radial fluid passage, and a second channel fluidly connecting the fourth fluid passage to the radial fluid passage.

4. The nozzle assembly of claim 2, wherein the first and second fluid passages are configured to direct a first flow of fluid within the housing, and the third and fourth fluid passages are configured to direct a second flow of fluid within the housing distinct from the first flow.

5. The nozzle assembly of claim 1, wherein the sleeve further includes a plurality of slots fluidly connected to the second fluid passage.

6. The nozzle assembly of claim 5, wherein the plurality of slots are configured to direct a fluid to a chamber of the nozzle assembly disposed proximate the orifice.

7. The nozzle assembly of claim 5, wherein the sleeve further defines a bypass passage fluidly connected to the plurality of slots.

8. The nozzle assembly of claim 7, wherein the bypass passage assists in fluidly connecting the first fluid passage and the second fluid passage.

9. The nozzle assembly of claim 7, wherein the bypass passage is fluidly connected to at least one of the chamber, the orifice, and the plurality of slots.

10. The nozzle assembly of claim 7, wherein the bypass passage extends from the front end of the sleeve to a back end of the sleeve.

11. The nozzle assembly of claim 1, further including at least one valve controllably fluidly connected to the housing and configured to assist in controlling a flow of fluid within the housing.

12. The nozzle assembly of claim 1, further including a stop disposed adjacent to the sleeve and fluidly connected to the third fluid passage.

13. A nozzle assembly, comprising:
a housing defining a first fluid passage in fluid communication with a second fluid passage, and a third fluid passage in fluid communication with a fourth fluid passage;
a sleeve disposed within the housing, the sleeve defining a bypass passage configured to assist in fluidly connecting the first fluid passage and the second fluid passage, the housing further defining a radial fluid passage proximate a front end of the sleeve; and
at least one orifice in selective communication with a regeneration device.

14. The nozzle assembly of claim 13, wherein the housing further defines a first channel fluidly connecting the third fluid passage to the radial fluid passage, and a second channel fluidly connecting the fourth fluid passage to the radial fluid passage.

15. The nozzle assembly of claim 13, wherein the first and second fluid passages are configured to direct a first flow of fluid within the housing, and the third and fourth fluid passages are configured to direct a second flow of fluid within the housing distinct from the first flow.

16. The nozzle assembly of claim 13, wherein the sleeve further includes a plurality of slots fluidly connected to the second fluid passage.

17. The nozzle assembly of claim 16, wherein the plurality of slots are configured to direct a fluid to a chamber of the nozzle assembly disposed proximate the orifice.

18. The nozzle assembly of claim 17, wherein the bypass passage is fluidly connected to at least one of the chamber, the orifice, and the plurality of slots.

19. The nozzle assembly of claim 16, wherein the bypass passage is fluidly connected to the plurality of slots.

20. The nozzle assembly of claim 13, wherein the bypass passage extends from the front end of the sleeve to a back end of the sleeve.

21. The nozzle assembly of claim 13, further including at least one valve controllably fluidly connected to the housing and configured to assist in controlling a flow of fluid within the housing.

22. The nozzle assembly of claim 13, further including a stop disposed adjacent to the sleeve and fluidly connected to the third fluid passage.

23. A method of cooling a portion of a nozzle assembly, comprising:
controllably restricting a flow of a first fluid to at least one of a first fluid passage and a second fluid passage of the nozzle assembly; and
directing a flow of a second fluid to a radial fluid passage of the nozzle assembly, the first fluid being a different fluid than the second fluid.

24. The method of claim 23, further including providing a valve upstream of at least one of the first and second fluid passages configured to assist in controllably restricting the flow.

25. The method of claim 23, further including directing the flow of the second fluid from a fourth fluid passage of the nozzle assembly to a third fluid passage of the nozzle assembly.

26. The method of claim 25, wherein the third fluid passage is fluidly connected to the radial fluid passage via a first channel of the nozzle assembly.

27. The method of claim 25, wherein the fourth fluid passage is fluidly connected to the radial fluid passage via a second channel of the nozzle assembly.

28. The method of claim 23, wherein at least one of the first fluid passage and the second fluid passage is in fluid communication with a regeneration device while the flow of the second fluid is directed to the radial fluid passage.

29. The method of claim 23, wherein the first fluid is a fuel and the second fluid is a coolant.
